(19) United States
(12) Patent Application Publication
(10) Pub. No.: US 2011/0265308 A1
(43) Pub. Date: Nov. 3, 2011

(54) System and Method For Providing Disposable Drawer Inserts For Medical And Surgical Carts

(75) Inventors: Kathy D. Giese, College Station, TX (US); Brett A. Tweedie, Beach Park, IL (US); Edward T. Turner, III, Conifer, CO (US); Sharon C. Alwin, Gurnee, IL (US)

(73) Assignee: Medline Industries, Inc., Mundelein, IL (US)

(21) Appl. No.: 13/183,160

(22) Filed: Jul. 14, 2011

Related U.S. Application Data
(62) Division of application No. 11/983,376, filed on Nov. 8, 2007.

(51) Int. Cl. B23P 11/00

(52) U.S. Cl. 29/428

(57) ABSTRACT

A disposable drawer insert system and method is disclosed for refilling components in medical and surgical carts. The disposable drawer insert system and method includes at least one disposable drawer insert adapted for insertion into one or more drawers in the carts and a predetermined set of components resident in the at least one disposable drawer insert. The predetermined set of components is associated with medical and surgical procedures. The at least one disposable drawer insert containing the predetermined set of components is packaged and delivered as a single unit for insertion into the carts.

The present invention relates generally to medical and surgical carts for storing medical and surgical supplies to be used in medical and surgical procedures. More particularly, the present invention relates to disposable, replaceable drawer inserts for medical and surgical carts having prepackaged items for medical and surgical procedures.

### BACKGROUND OF THE INVENTION

Medical and surgical facilities typically employ a central supply department for the restocking of medical and surgical carts with medical supplies. The medical and surgical supplies are often ordered in case quantities and are used to stock multiple medical and surgical carts. The restocking process is labor and time intensive. The time spent by nurses and medical staff restocking medical and surgical carts could be used to attend to patient-related or other needs. Once the medical or surgical cart is restocked, the excess items are usually returned to a central supply room, which may require additional time on the part of the nurse or staff to return supplies to their proper locations. This time too could be spent on patient-related or other needs.

In addition to the labor and time needs, disadvantages of this system include the possibility of cross-contamination when medical staff add or remove items from the medical or surgical cart and put them back in the central supply department. It is also possible that drawers may be restocked with no cleaning of the cart and/or drawers such that contamination of drawers may persist even after restocking occurs. Thus, cross-contamination can occur when contaminants are spread from one drawer to another drawer in a medical or surgical cart, or when items are returned to the central supply department. Furthermore, the items in the cart may not be properly rotated to avoid exceeding the expiration dates on certain items. Thus, expired products may go unnoticed in a medical or surgical cart and may put hospitals and healthcare facilities at risk of violating safety compliance standards.

Unorganized and messy carts may also raise potential safety/health-related issues as nurses and staff may waste valuable minutes searching for items in an unorganized cart during an emergency, where that time could be better spent focusing on the needs of the patient. For example, items that are most often used may be near the back of the drawer while lesser used items may be near the front of the drawer. Being unable to locate the most necessary items in a few seconds may cause an already tense, emergency situation to become worse.

Another disadvantage is that large, high-volume inventories are needed to be housed and organized in the hospital or healthcare facility to be able to stock the medical and surgical carts, requiring space that could be used for other needs. Furthermore, such high-volume inventories may not be, standardized to reflect the optimum quantities or types of items that are needed in the medical and surgical carts, i.e., a particular item may be ordered in large quantities because of the way items are packaged from suppliers even though certain procedures and medical and surgical carts require only a small inventory of the item.

Therefore, there exists a need for a unique solution that assists medical and surgical facilities in refilling the components in the medical and surgical carts at the clinical point of use versus ordering components in case quantities and stocking multiple carts in multiple locations. Such a system would also desirably reduce supply handling touch points by decreasing the number of times that an item will be physically handled before reaching its point of use, improve staff productivity by maximizing the efficient use of nurses and staff while delivering good patient care, reduce the chances of cross-contamination by reducing the presence of contaminated items in carts, reduce inventory by offering programs for consignment or return of unused items, reinforce safety compliance by monitoring compliance with safety standards and offering recommendations to maintain compliance, standardize high-volume medical supply utilization by providing standard sets of supplies in all similar carts throughout the medical and surgical facilities, and solve supply management challenges by providing sufficient quantities of items without the need to store large excess amounts.

### SUMMARY OF THE INVENTION

According to one embodiment of the present invention, a disposable drawer insert system for refilling components in a medical or surgical cart is disclosed. The disposable drawer insert system comprises at least one disposable drawer insert adapted for insertion into one or more drawers in the cart and a predetermined set of components resident in the at least one disposable drawer insert. The predetermined set of components is associated with a medical or surgical procedure. The disposable drawer insert containing the predetermined set of components is packaged and delivered as a single unit for insertion into the cart.

In another embodiment of the present invention, a method for providing a disposable drawer insert system for refilling a medical or surgical cart is disclosed. The disposable drawer insert system includes a plurality of disposable drawer inserts adapted for insertion into the medical or surgical cart. Each of the disposable drawer inserts contains a predetermined set of components associated with a medical or surgical procedure. The method comprises the acts of (a) inserting a first disposable drawer insert into the cart; (b) after a predetermined quantity of the components has been depleted, removing the first disposable drawer insert from the cart; (c) inserting a second disposable drawer insert into the cart; and (d) repeating steps (b) and (c) above after the predetermined quantity of components has been depleted.

In yet another embodiment of the present invention, an apparatus for storing items associated with a medical or surgical procedure is disclosed. The apparatus comprises a mobile cart, at least one disposable drawer insert adapted for insertion into the mobile cart and a plurality of components for use during the medical or surgical procedure that are resident in the at least one disposable drawer.

In a further embodiment of the present invention, a method for reducing cross-contamination of a medical or surgical cart is disclosed. The method comprises the acts of providing a plurality of disposable drawer inserts adapted for insertion into the cart. The plurality of disposable drawer inserts house a predetermined set of medical or surgical components. The method also comprises inserting a first one of the plurality of disposable drawer inserts into the cart and allowing a predetermined quantity of the components to be depleted. The method further comprises removing the first one of the plurality of disposable drawer inserts after the predetermined quantity of components has been depleted and replacing the first one of the plurality of disposable drawer inserts with a replacement drawer insert having medical or surgical components housed therein.

In a still further embodiment of the present invention, a method for controlling inventory contained in a medical or surgical cart is disclosed. The method comprises the acts of providing a disposable drawer insert adapted for insertion into the cart. The disposable drawer insert has segmented compartments. The method also comprises housing a predetermined set of components within the segmented compartments. The method further comprises providing a replacement disposable drawer insert after a predetermined quantity of the components of the disposable drawer insert has been depleted.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a medical or surgical cart for housing drawer inserts according to one embodiment of the present concepts.

FIG. 2A is an exploded view of a drawer insert having a plurality of dividers.

FIG. 2B is a perspective view of the drawer insert of FIG. 2a.

FIG. 3 is a perspective view of a drawer insert having a predetermined set of medical and/or surgical components arranged in a plurality of compartments according to another embodiment of the present concepts.

FIG. 4 is a perspective view of a mobile cart for carrying pre-packed drawer inserts to be supplied to medical and surgical carts.

FIG. 5A is an exploded view of another embodiment of a drawer insert having a plurality of dividers.

FIG. 5B is a perspective view of the drawer insert of FIG. 5a.

FIG. 6A is an exploded view of a further embodiment of a drawer insert having a plurality of dividers.

FIG. 6B is a perspective view of the drawer insert of FIG. 6a.

FIG. 7 is a perspective view of an embodiment of a drawer insert having a single compartment.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

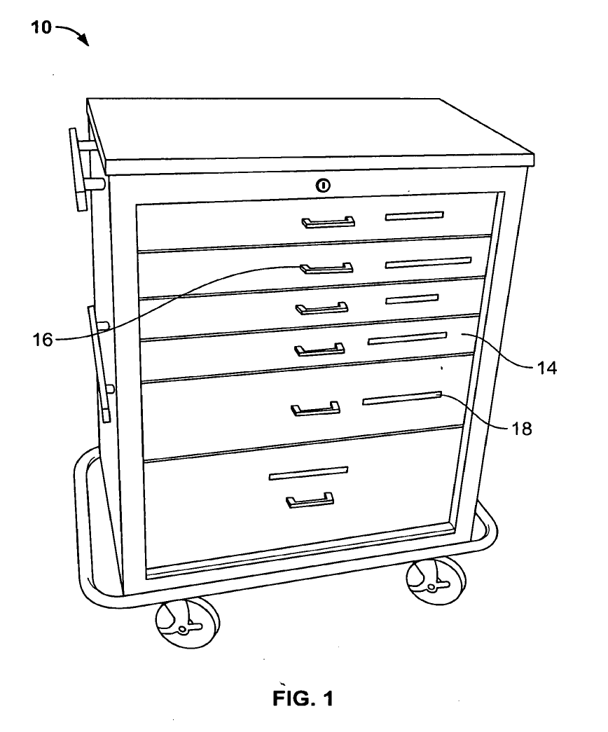

FIG. 1 illustrates a medical or surgical cart 10 for storing medical and surgical supplies that are used in medical and surgical procedures. The medical or surgical cart 10 has a plurality of drawers 14. The drawers 14 may have different sizes such that the drawers hold various types and quantities of medical and surgical items. The medical or surgical cart 10 may generally hold from about four to six drawers 14, although more or less drawers 14 may be included in the medical or surgical cart 10 depending on the size of the drawers 14 and the size of the medical or surgical cart 10. Typical drawer sizes may vary in their dimensions, however, some typical drawer sizes may include drawers with depths of about 3 inches (about 7.6 cm) and about 5 inches (about 12.7 cm).

To open the drawers 14, a handle 16 is attached to each of the drawers 14 in order to pull the drawer 14 out of the medical or surgical cart 10 to make the contents of the drawer 14 available to a nurse or medical staff In other embodiments, the drawers 14 may have no handles and instead may have other means for opening the drawers 14, such as by pressing on a portion of the drawer 14 to dislodge it from the medical or surgical cart 10. The drawer 14 may contain medical and surgical items for one or multiple medical and surgical procedures. In other words, different types of medical and surgical items may be needed for different medical and surgical procedures and the corresponding medical and surgical carts 10. Examples of such medical and surgical carts include anesthesiology carts, pain and block carts, endoscopy carts, isolation carts, trauma emergency room carts and trauma operating room carts, ambulatory surgery carts, labor and delivery carts, intensive care unit (ICU) carts, catheter lab carts, etc. Other types of medical and surgical carts 10 include specialty carts such as latex-free carts, casting supply carts, orthopedic carts, neurology carts, cystoscopy carts, Broselow pediatric crash carts and adult crash carts. In some carts 10, the drawers 14 may have a label (or labels) 18 attached which describes the types of items included in the drawers 14.

As discussed above, the medical and surgical carts 10 may be stocked with items that are specific to a type of procedure that may be conducted at a medical or surgical facility. Such a facility may include any type of healthcare facility or system that uses a medical or surgical cart in some type of supply rotation, such as facilities which perform surgical procedures, both in-patient and out-patient. For example, in the case of anesthesia carts, such carts may be used in operating and emergency rooms, ambulatory surgery, labor and delivery, etc. Thus, anesthesia carts may require medical and surgical items that vary with the specific type of procedure, as well as with the different types of anesthesia that are administered, such as general, local, spinal, bier block regional, conscious sedation and facet/pain. Thus, the refilling of items in the medical and surgical carts 10 can be a very labor and time intensive process to make sure all of the correct items are placed into the medical and surgical carts 10 for the proper medical and surgical procedures. Having too few of a necessary item may cause valuable minutes to be wasted as the nurse or medical staff searches for a particular item needed for a medical or surgical procedure.

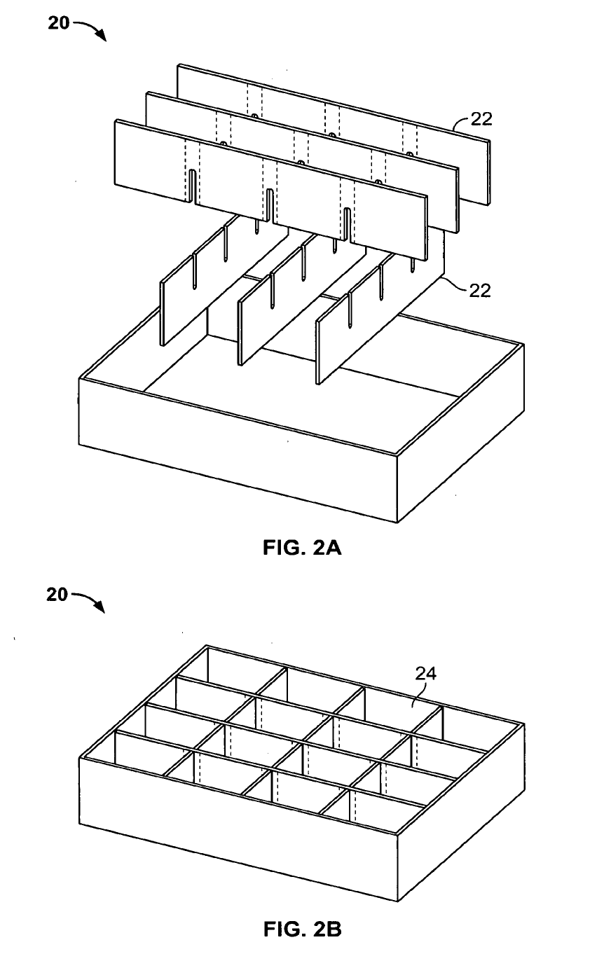

According to one embodiment, a drawer insert 20 may be provided which is replaceable or exchangeable and which may be removed and disposed of after use. The drawer insert 20 may be designed to fit into the drawers of any commercially available medical or surgical cart 10, including both metal and plastic carts, with little or no alteration of the cart being necessary. The drawer insert 20 may include a plurality of dividers 22 for providing a plurality of medical or surgical compartments 24 for holding, organizing and displaying a set of components, as shown in FIGS. 2A and 2B. The compartments 24 may be of various sizes to accommodate various shapes, sizes and quantities of the medical or surgical components. The example shown in FIGS. 2A and 2B is a drawer insert 20 having sixteen equal-sized compartments 24. The drawer insert 20 may be about 5 inches deep (about 12.7 cm).

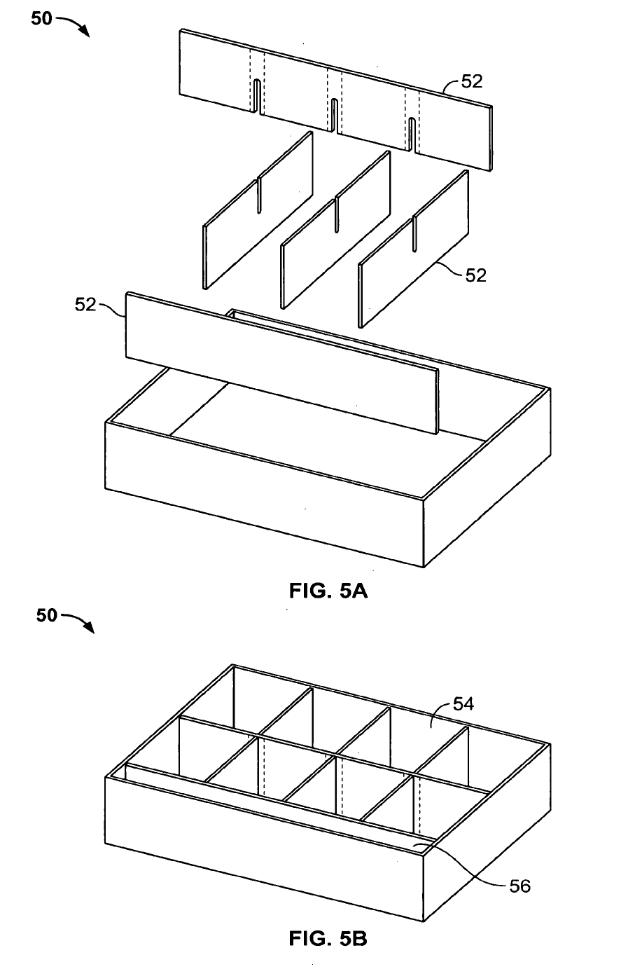

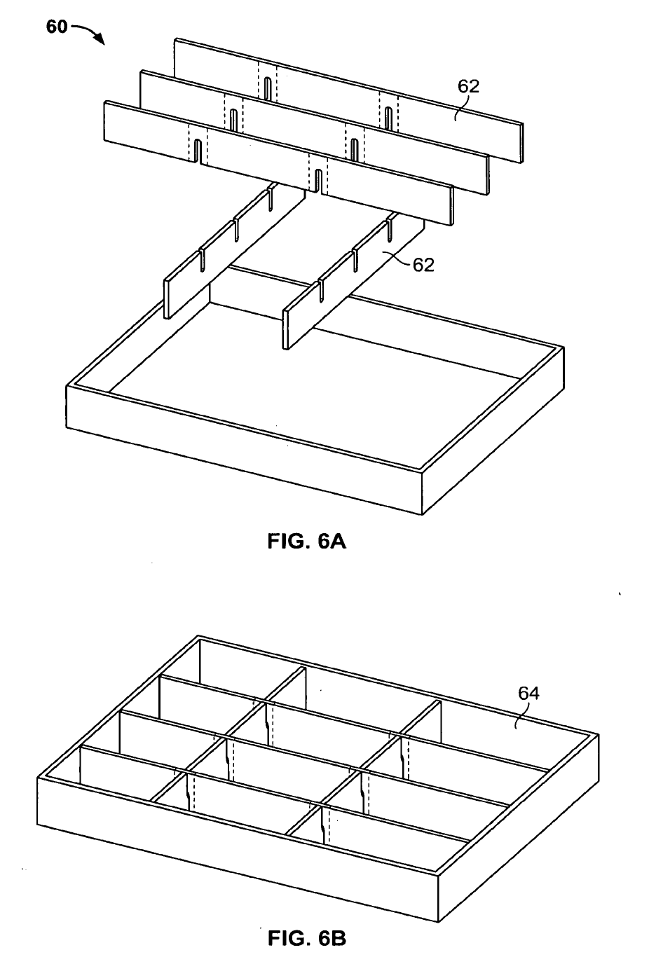

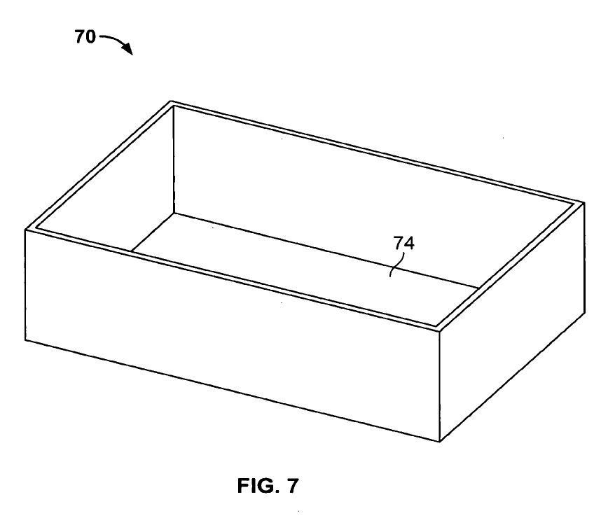

In other embodiments, different sizes and numbers of dividers 22 may be used to provide drawer inserts 20 having different numbers and sizes of compartments 24, such as the embodiments shown in FIGS. 5A, 5B, 6A, and 6B. FIGS. 5A and 5B, for example, illustrate a drawer insert 50, having dividers 52 for providing eight equal-sized compartments 54 and one narrow, rectangular compartment 56. FIGS. 6A and 6B, for example, illustrate a drawer insert 60, having dividers 62 for providing twelve equal-sized compartments 64. The drawer insert 50 in FIGS. 5A and 5B may be about 5 inches (about 12.7 cm) deep; the drawer insert 60 in FIGS. 6A and 6B may be about 3 inches (about 7.6 cm) deep. FIG. 7 is an example of a drawer insert 70 having no dividers and thus a single compartment 74. This drawer insert 70 may be used to hold larger items, such as an anesthesia machine, and may also be about 5 inches (about 12.7 cm) deep. Some of the drawer inserts, specifically 20, 50 and 60 (in FIGS. 2A, 2B, 5A, 5B and 6) can be altered by tearing at perforations contained in the respective dividers, 22, 52 and 62.

The drawer inserts 20 (also 50, 60 and 70, but hereinafter referred to collectively as 20) shown in FIGS. 2A, 2B, 5A, 5B, 6A, 6B and 7 may be made from corrugate board, such as white, pressed corrugate board, or E-Flute corrugate, or combinations thereof A commercial supplier of this type of board is Wes-Pak Inc. of Little Rock, Ark. Alternatively, the drawer inserts 20 may be made from paper board, rubber, chipboard or plastics, such as polyethylene, polyvinylchloride, nylon, and polypropylene, or combinations thereof Plastic drawer inserts 20 may be produced by various methods, such as rotational molding (i.e. roto-molding), thermoforming, pressure forming, vacuum forming, injection molding or blow molding. It should be noted, however, that all of the drawer inserts 20 described herein may be disposed of after use in a medical or surgical cart 10.

According to some embodiments, the disposable drawer inserts 20 are prepackaged with medical or surgical components relating to a particular medical or surgical procedure, such as, for example, administering anesthesia. The quantity and types of such components may be determined prior to being packaged in the drawer insert 20, depending on the particular medical and surgical procedures, and with the input of doctors, nurses and staff. Once the predetermined components are arranged in the drawer insert 20, the entire unit (i.e., drawer insert 20 and predetermined components) is packaged as a single unit. When needed, this single unit is unwrapped and placed in the medical or surgical cart 10 to replace existing drawer inserts 20 that have used some or all of the existing components for one or more medical or surgical procedures. It is estimated that the drawer inserts 20 may include an average of 65 components, although any number may be included as desired for a given use.

As mentioned above, to assist in providing prepackaged drawer inserts 20 that have the necessary components for particular medical and surgical procedures, hospital and healthcare facility staff and nurses may provide input as to the types of components routinely used and the average quantities, known as par levels, of the components in the drawer inserts 20. Replacement drawer inserts 20 with a given set of components can then be prepared and provided on a periodic basis, i.e., once a day, every other day, etc., to the hospital or healthcare facility for placing in the medical and surgical carts 10 when the existing drawer inserts 20 are ready to be replaced. Such a disposable, prepackaged drawer system with a predetermined set of components assists hospitals and healthcare facilities in reducing the time and cost to have nurses or medical staff stock the medical and surgical carts 10 from a central supply department. Instead of spending valuable time identifying each medical item needed, looking for each medical item needed, transporting the items, restocking them in the medical or surgical cart 10, and cleaning the drawers (when needed), nurses and medical staff simply remove a used drawer insert 20 from the medical or surgical cart 10, identify the appropriate prepackaged replacement drawer insert 20, remove the packaging around the replacement drawer insert 20, and insert the replacement drawer insert 20 into the open drawer 14 in the medical or surgical cart 10.

Such a program may save lives during medical and surgical procedures as a nurse does not have to search for items when an emergency arises. An organized drawer insert 20, with the items used most often arranged to be easily accessible, will reduce the time needed to locate necessary items and will allow the nurse to focus on the needs of the patient, doctor or other staff members. In such emergency situations, the standardization of supplies is critically important so that patient care is not jeopardized. Furthermore, nurses and medical staff, as well as materials management staff, will realize a time savings due to a reduction in ordering, receiving, stocking shelves, and pulling and stocking carts. They will be able to spend more time accomplishing other needed tasks such as filling lines, such as I.V. priming, labeling syringes, managing laryngoscope blades and handles and spending more time with patients.

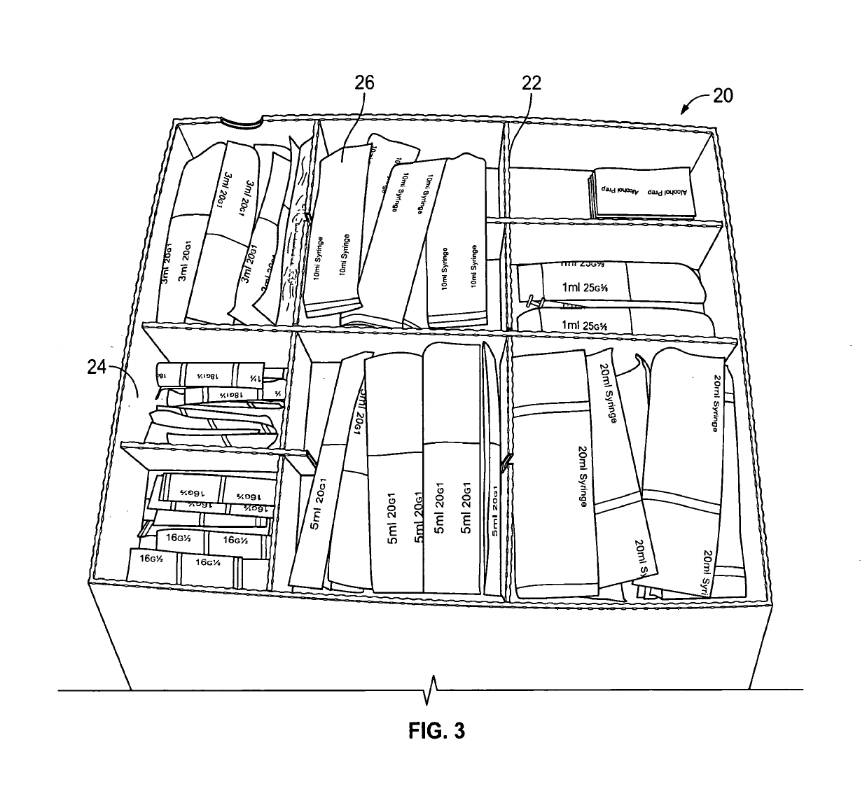

FIG. 3 illustrates an embodiment of the drawer insert 20 holding a set of predetermined components associated with specific medical and surgical procedures. In this example, eight compartments 24 hold different types of components 26 arranged according to the type and size of the components 26. For example, the individual compartments 24 may hold a quantity of 5 ml syringes, a quantity of 20 ml syringes, a quantity of 1 ml syringes, a quantity of 10 ml syringes, a quantity of 3 ml syringes, and a quantity of alcohol wipes. As shown in FIGS. 2, 3, 5, 6 and 7, varying numbers and sizes of compartments 24 may be designed to hold different types of components 26 needed for medical and surgical procedures. This example of the drawer insert 20 in FIG. 3 may be used in an anesthesia cart, however, it will be recognized by one skilled in the art that many different components 26 associated with different types of medical and surgical procedures may also be placed in the drawer insert 20 and that medical and surgical carts 10 may be associated with different medical and surgical procedures.

In some embodiments, the systems and methods as described herein may include drawer inserts 20 having components 26 that may be predetermined or customized according to the needs of the hospitals or healthcare facilities. Thus, a hospital or healthcare facility may designate the particular components 26 to be included in one or more of the drawer inserts 20. In other embodiments, the components 26 in the drawer inserts 20 may be standard supplies for a given medical or surgical procedure such that a hospital or healthcare facility can simply order a prestocked/preselected drawer insert 20, such as a prestocked/preselected labor and delivery drawer insert, a prestocked/preselected open heart surgery drawer insert, a prestocked/preselected anesthesiology drawer insert, etc. The hospitals or healthcare facilities may also designate which components 26 are to be placed in which compartments 24 within the drawer insert 20. For example, it is most useful and efficient to have the most-used components 26 preplaced in a front portion of the drawer insert 20 and the less-used components 26 preplaced in a back portion of the drawer insert 20.

To provide examples' of components 26 that may be included in the drawer inserts 20, an anesthesia cart may include the following components: extension tubes, needles, syringes, stopcocks, cathlons and fluids for I.V. therapy; laryngeal mask airways (LMAs), airways, E.T. tubes, stylets, temperature probes, nasal pharyngeal airways and circuits for intubation therapy; medications, needles, syringes, alcohol pads and preps, such as chlorhexidene gluconate (CHG), for medication therapy; and masks and oxygen tubing for oxygen therapy, extubation and transport. The above items may be used in other carts, in addition to anesthesia carts, such as crash carts, pain and block carts and endoscopy carts.

Once the drawer inserts 20 containing the predetermined set of components are packaged and delivered to the hospital or healthcare facility, a program may be developed for restocking of the medical and surgical carts 10. Such a program may include providing a rack cart 30 for storing and transporting the drawer inserts 20 from one location to another. The rack cart 30 includes a set of four wheels 32 for maneuvering the rack cart 30 to deliver the prepackaged drawer inserts 20 to the medical and surgical carts 10. The rack cart 30 is also designed to allow the hospital or healthcare facility to quickly transport emergency supplies to a triage area for a Disaster Preparedness Program. The rack cart 30 may include shelving 34 for holding different sizes of the prepackaged drawer inserts 20. In this example, the smaller prepackaged drawer inserts 20 are shelved above the larger prepackaged drawers inserts 20. Alternatively, any variation of organizing the drawer inserts 20 which may be suitable for meeting a hospital's or healthcare facility's needs may be used.

Prior to restocking the medical or surgical cart 10 with the disposable drawer inserts 20, the used drawer inserts 20 may be removed from the medical or surgical cart 10 and the medical or surgical cart 10 may be cleaned by washing or wiping the medical or surgical cart 10. With prior systems, each item would have to be used or emptied from the drawer 14 before cleaning. Furthermore, once items were removed from the cart in prior systems and used to restock the medical and surgical carts 10, such items could be unclean if they were in a drawer 14 that was also unclean. In the present system, cleaning of the medical and surgical carts 10 is more easily performed due to the ease of removing and inserting the drawer insert 20 and unclean, contaminated items are less likely to be transferred from one drawer 14 to another or transferred back to a central supply department.

After cleaning, the disposable drawer insert 20 may be inserted into the medical or surgical cart 10. Smaller drawer inserts 20 are generally inserted at the top portion of the medical or surgical cart 10, while larger drawer inserts 20 are generally inserted at the bottom portion of the medical or surgical cart 10. Other suitable arrangements may be used based on a hospital's or healthcare facility's internal procedures or desire to have a specific arrangement of items in the medical or surgical cart 10.

Any unused supplies may be handled in different manners in the system described herein. For example, unused supplies may be placed on top of a new drawer insert 20. These unused supplies, when taken from the present drawer inserts 20, will remain clean because they are not in contact with unclean parts of the drawer 14 which may rarely be washed in the prior system. This is an improvement over the prior system which allowed supplies to remain in the carts even after they may have become dirty or contaminated.

In some embodiments, a return program may be implemented that allows the hospital or healthcare facility to receive credit for unused supplies. In other embodiments, a consignment program may be utilized that allows hospital or healthcare facilities to pay for supplies after they have been used by the hospital and healthcare facilities. It is contemplated that any one or a combination of programs described herein may be implemented at hospitals or healthcare facilities in connection with the unused items of the drawer inserts 20 of the present system.

In yet other embodiments, it is contemplated that the information regarding the unused supplies may be documented, including an identification of the quantities and types of unused supplies, and that this information may be used to modify the predetermined set of components that are provided with subsequent drawer inserts 20. This would assist a hospital or healthcare facility in quantifying and tracking supply usage to better preselect which components are to be placed in the drawer inserts based on the needs of a particular hospital or healthcare facility. This also allows for proper modifications to be made to the predetermined set of components to take into account items that are used less frequently and to increase the supply of items that may be used more frequently.

Under some conditions, the individual components 26 may be sterilized such that the individual components 26 can be used in a sterile environment. To be used in a sterile environment, the drawer inserts 20 are stocked with the appropriate sterile components 26 in a clean room. Providing sterile components that are packaged in a drawer insert 20 in a clean room offers increased assurances that the items, once reaching their point of use, will remain sterile. In other scenarios, the components 26 may be “clean” or disinfected, although they are not sterile. For easier identification, special labels (not shown) may be used to indicate the front, back and sides of the prepackaged drawer inserts 20, for proper orientation of the drawer insert 20 as it is inserted into the medical or surgical cart 10. Other labels may indicate which components (types and sizes) are packaged in the drawer insert 20, as well as the particular drawer 14 number (i.e., drawer 1, drawer 2, etc.) in which the drawer insert 20 is inserted.

After the drawer inserts 20 are prepared and are ready to be shipped to the hospitals and healthcare facilities, the drawer inserts 20 are shrink-wrapped and then placed in shipping containers, such as boxes. This “layering” of protective packaging provides increased precautions to maintain the sterility or cleanliness of the supplies as they are transported to the medical and surgical facilities. Preferably, the boxes may hold five or six 3-inch deep drawers or two or three 5-inch deep drawers. At these quantities, the boxes will weigh less than 50 pounds and will not exceed the maximum weight as specified by O.S.H.A. guidelines.

The general types and quantities of components 26 in the prepackaged, disposable drawer inserts 20 may be periodically modified by hospital or healthcare facility personnel to update the components based on usage or other factors. Such drawer replenishment programs as described herein which may be available commercially include the Anesthesia Complete Delivery System (ACDS) or the Anesthesia Case Cart Replenishment Program—Drawer Exchange which are available from Medline Industries, Inc. of Mundelein, Ill. Specifically, such systems assist hospitals and healthcare facilities with the safe and efficient rotation of anesthesia supplies while providing a means of standardizing to improve emergency response for better patient safety.

As illustrated in the embodiments presented in the present application, a drawer refilling/restocking program which provides prepackaged, replaceable drawer inserts 20 for medical and surgical carts 10 reduces the handling of medical and surgical supplies by nurses and medical staff, thereby improving productivity and allowing nurses and medical staff to spend more time on patient-related needs. Such a program also reduces the chances of cross-contamination of items stocked in the medical and surgical carts 10 as well as reinforces product safety compliance by, for example, ensuring removal of expired items from the medical and surgical carts 10. Overall drawer cleanliness is also improved by the removal and disposal of drawer inserts 20 on a routine basis. Moreover, by better managing the medical supplies that are needed by the hospital or healthcare facility, inventory is reduced and the utilization of anesthesia supplies is standardized. Thus, such drawer inserts and methods of providing the drawer inserts offer unexpected advantages over the restocking of medical and surgical carts by a central supply department.

Other clinical advantages of the drawer inserts and methods of providing the drawer inserts include having the right medical items when needed at a specific time and place to reduce the time spent searching for items; decreasing the risk of opened, unused or contaminated items; the ability to stock items by therapy, such as I.V., intubation, medication, or O₂/extubation/transport; standardizing medical and surgical cart drawers across a hospital or healthcare facility; organizing medical items to save valuable time during emergency situations when the readiness and availability of drawer components is most critical; freeing staff time for clinical support such as medication labeling; reducing supply picking errors which may result in the wrong items being included in the medical or surgical cart; providing Surgical Care Improvement Project (SCIP) recall capabilities for rapid notification of any item which may be affected in a manufacturer recall to avoid any risk to the patient; and meeting or exceeding some or all of the standards for the Association of Perioperative Registered Nurses (AORN), the Joint Commission on Accreditation of Healthcare Organizations (JCAHO), the Surgical Care Improvement Project (SCIP), the Joint Commission's Board of Commissioners on National Patient Safety Goals and others.

Examples of standards and practices that are met or exceeded by the drawer inserts 20 and methods described herein include (1) the AORN Safe Medication Practices in Perioperative Practice Setting, 2006 Standards, Recommended Practices and Guidelines (p. 321), http://www.aorn.org, for medication labeling; (2) the AORN Latex Guidelines, 2006 Standards, Recommended Practices, and Guidelines (p. 199), and Biological AORN Document List, http://www.aorn.org, for latex-free components; (3) the AORN Position Statement on Workplace Safety, 2006 Standards, Recommended Practices, and Guidelines and Biological AORN Document List, http://www.aorn.org, for needle safety and infection control; (4) the NIOSH alert: “Preventing needlestick injuries in health care settings,” the U.S. Department of Health & Human Services, National Institute for Occupational Safety & Health (NIOSH) (November 1999), http://www.cdc.gov/niosh, for needle safety and infection control; (5) “Health Care Workers,” U.S. Department of Health & Human Services, National Institute for Occupational Safety & Health, http://www.cdc.gov/niosh, for needle safety and infection control; (6) “Hospital safety climate and its relationship with safe work practices and workplace exposure incidents” American Journal of Infection Control, Vol. 28, July 2001 (p. 211-221), for needle safety and infection control; (7) the National Patient Safety Goals, 2007 National Patient Safety Goals approved by Joint Commission's Board of Commissioners, Goal 3 & 3D, http://www.jointcommission.org/PatientSafety/NationalPatientSafetyGoals, for patient safety; and (8) the SCIP (Surgical Care Improvement Project) Redesign Processes to Standardize to Improve Care & Consistency: Infection Control, http://www.medqic.org/dcs Medicare Quality Improvement Community, for patient safety.

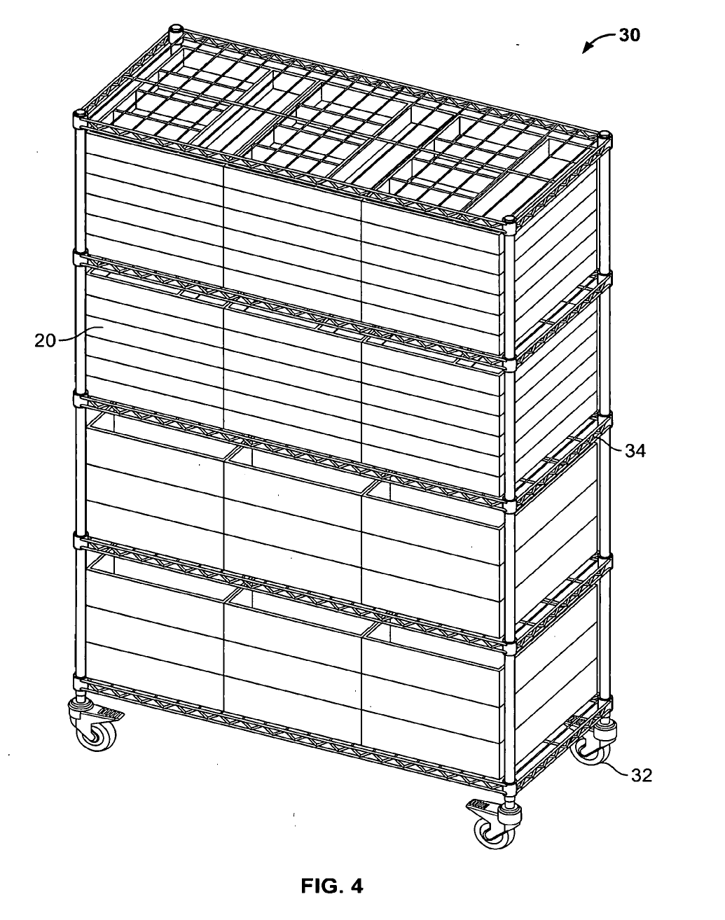

Other logistical advantages of the drawer inserts 10 and methods of providing drawer inserts 10 include a significant reduction of inventory levels; the use of drawer inserts 10 to manage a majority of items that are stocked in medical and surgical carts 10; a reduction of the number of items to count for physical inventory; a drastic reduction in touch points (or handling points) of items and purchase orders; a streamlined positioning of items inside each drawer insert 10 such that for similar drawer inserts 10, items are in the same compartments 24 in the same quantities for faster and easier identification of items; the elimination of excess and expired items inside the drawer inserts 10; an improved utilization and design of space for receiving medical and surgical items so that all items are placed in compartments so that they can be quickly found when needed; an advanced notification of manufacture backorder of supplies, along with possible substitutes, such that a user of the program will know well ahead of time of possible shortages of supplies; and improved disaster preparedness response to evacuate supplies to a triage site via the mobile exchange rack (see FIG. 4).

Some financial advantages of the drawer inserts and the methods of providing drawer inserts include a reduction in the distribution costs based on the purchase of a single drawer instead of purchasing components individually; the option of a consignment and return program; a contract rebate option such that a user of the program receives a certain percentage of the cost in a rebate; the option to provide costs which are equal or lesser than manufacturer fees to the users of the program; a preferred component program for offering preferred items at a lesser cost; a reduction in freight costs and other charges that are often incurred when ordering supplies; easier identification of costs per procedure for healthcare programs such as Medicare by providing the documentation necessary to determine the number of items used per number of procedures performed; and a reduction in the number of employees and hours needed to maintain the drawer insert replenishment program as compared to the number of employees and hours needed in a central supply department.

One example of a procedure that the disposable drawers may be used in connection with is provided below. This procedure may be adopted to provide a process which allows for the safe and efficient rotation of supplies while providing a means of standardizing to improve emergency response for better patient safety. Furthermore, the procedure may insure that all supplies at point-of-use are rotated to prevent expired and opened/unused products and to facilitate that drawers are wiped down and checked for contamination to prevent possible cross-infection. Such procedures assist in solving supply management challenges and are provided to meet or exceed the standards for National Patient Safety Goals, SCIP, AORN and JCAHO. The procedure may include the following steps:

(1) Set up a cart replenishment program with desired items to stock drawers for a specific therapy based on par level, or average, quantities used over a certain time period. Pay special attention to stocking items which may expire to insure that the drawer is rotated regularly. Manage any lesser- or rarely-used items as an exception outside of the cart replenishment program.

(2) Stock drawers by therapy, such as I.V., airway, intubation, medication/syringe, anesthesia circuit, or transport/O₂, so that providers will have quick and easy access to items without, opening multiple drawers.

(3) Review a physical sample of a drawer insert and insure that it fits inside each cart drawer in the hospital or healthcare facility. The program allows for product standardization within the hospital or healthcare facility.

(4) Implement a program utilizing drawer inserts and reduce items in case quantity on inventory shelves. This will help minimize excess and expired items. Reduce existing inventory through use in other clinical areas and in other rooms that are outside the scope of the program or through a return program.

(5) Reorganize stock to accommodate drawers and reduce par levels for individual items stocked on shelves that are now contained in drawers that are part of the drawer replenishment program. Avoid ordering case quantities of any items now included in the cart replenishment program.

(6) Provide ongoing in-service sessions on the cart replenishment program for all staff and those persons administering or using the items.

(7) Pull required items from the drawers as per normal operating procedure as needed for performance of surgical or medical procedures during the course of the day per room.

(8) Ensure that technicians check cart drawers every shift for stock levels. Remove depleted drawer inserts as needed and wipe down drawer with hospital-approved cleaning agent and replace with new drawer insert to restock.

(9) Replace any excess items from depleted drawer insert on top of new drawer insert or on shelf. This process will support first in and first out distribution initiative but must include visual inspection of product to insure that it has not been compromised. Dispose of any questionable or open, unused items. Communicate any excess stock items for changing drawer inventories to reduce extra stock on hand.

(10) Use any used, clean empty drawer inserts to organize specialty carts or follow normal disposal through hospital or healthcare facility waste policy and procedures.

(11) Reallocate time previously used in restocking carts to assist with room turn-over, medication labeling at point of use, I.V. therapy and transport.

(12) Continuously evaluate the appropriateness of the items and quantities in the drawer inserts. Consider updates related to new safety products and latex free content.

(13) Communicate any desired changes to the components in the drawer inserts in a timely manner so that changes can be made quickly to support nurses, doctors and other healthcare personnel.

(14) Document inventory reduction and time savings and expand or modify program as desired.

It is contemplated that other steps and/or procedures in addition to those described herein may be used in connection with the drawer inserts 20. Such procedures may include some or all of the steps described herein, and may also include other steps which are not specifically described herein but which may be included in a drawer exchange/replenishment program.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention, which is set forth in the following claims.

1-8. (canceled)

9. A method for providing a disposable drawer insert system for refilling a medical or surgical cart, the disposable drawer insert system including a plurality of disposable drawer inserts adapted for insertion into the medical or surgical cart, each disposable drawer insert containing a predetermined set of components associated with a medical or surgical procedure, the method comprising the acts of:
(a) inserting a first disposable drawer insert into the cart;
(b) after a predetermined quantity of the components has been depleted, removing the first disposable drawer insert from the cart;
(c) inserting a second disposable drawer insert into the cart; and
(d) repeating steps (b) and (c) above after the predetermined quantity of components has been depleted.

10. The method of claim 9, further comprising cleaning the cart.

11. The method of claim 9, further comprising documenting information relating to usage of the components.

12. The method of claim 11, wherein the information includes the quantities and types of any unused components.

13. The method of claim 11, further comprising modifying the predetermined set of components based on the documented information.

14-18. (canceled)

19. A method for reducing cross-contamination of a medical or surgical cart, the method comprising the acts of:
providing a plurality of disposable drawer inserts adapted for insertion into the cart, the plurality of disposable drawer inserts housing a predetermined set of medical or surgical components;
inserting a first one of the plurality of disposable drawer inserts into the cart;
allowing a predetermined quantity of the components to be depleted;
removing the first one of the plurality of disposable drawer inserts after the predetermined quantity of components has been depleted;
replacing the first one of the plurality of disposable drawer inserts with a replacement drawer insert having medical or surgical components housed therein.

20. The method of claim 19, wherein the predetermined set of medical or surgical components are sterilized or disinfected prior to insertion into the cart.

21. The method of claim 19, further comprising cleaning the cart before the insertion of the first one of the plurality of disposable drawer inserts.

22. The method of claim 19, further comprising cleaning the cart before the replacement of the first one of the plurality of disposable drawer inserts with the replacement drawer insert.

23. A method for controlling inventory contained in a medical or surgical cart, the method comprising the acts of:
providing a disposable drawer insert adapted for insertion into the cart, the disposable drawer insert having segmented compartments;
housing a predetermined set of components within the segmented compartments; and
providing a replacement disposable drawer insert after a predetermined quantity of the components of the disposable drawer insert has been depleted.

24. The method of claim 23, further comprising collecting any unused components for use in other disposable drawer inserts and issuing a credit for any unused components.

25. The method of claim 24, further comprising positioning the most-used components in a front portion of the disposable drawer insert and positioning the less-used components in a back portion of the disposable drawer insert.
